(19) United States
(12) Patent Application Publication
(10) Pub. No.: US 2026/0227537 A1
(43) Pub. Date: Aug. 6, 2026

(54) FOCAL MECHANISM INVERSION FOR DISTRIBUTED ACOUSTIC SENSING SYSTEM

(71) Applicant: Schlumberger Technology Corporation, Sugar Land, TX (US)

(72) Inventors: Takashi Mizuno, Sugar Land, TX (US); Jiuxun Yin, Sugar Land, TX (US); Yaolin Miao, Ann Arbor, MI (US)

(21) Appl. No.: 19/459,628

(22) Filed: Jan. 26, 2026

Related U.S. Application Data
(60) Provisional application No. 63/749,826, filed on Jan. 27, 2025.

(51) Int. Cl. G01V 1/30; G01H 9/00; G01V 1/00; G01V 1/20; G01V 1/28

(52) U.S. Cl. CPC G01V 1/30; G01H 9/004; G01V 1/003; G01V 1/20; G01V 1/288

(57) ABSTRACT

A method may include acquiring raw seismic data, computing event location and corresponding P and S wave arrivals, automatically obtaining polarity of the corresponding P and S waves arrivals, measuring fit of P and S wave polarity to a model to obtain a group of accepted solutions, analyzing distribution of the accepted solutions in the model, and identifying a best solution as a focal mechanism.

### CROSS-REFERENCE TO RELATED APPLICATIONS

The present application claims priority to United States Provisional Application 63/749,826 dated January 27, 2025, the entirety of which is incorporated by reference.

### BACKGROUND

Optical fiber triggers innovations in a wide range of subsurface acoustic sensing topics, including passive seismic applications. The acquisition of passive seismic data is getting renewed interest in not only the oil and gas industry, but also the Carbon Capture and Sequestration (CCS) industry and the geothermal industry. When it comes the oil and gas, CCS, and geothermal industries, one of the main reasons to perform a passive seismic monitoring survey is to obtain information on ongoing deformations associated with production and/or injection. The location of passive seismic events depicts an area where deformation is occurring, and its source parameter for each event describes the kinematic nature of each event.

In terms of source parameters, moment tensor (6 parameters) is one of the parameters often estimated by the three-component geophone-based acquisition system. However, the problem becomes impractical in optical fiber measurement because it measures only single components (parallel to the fiber optics cable direction). The problem needs to be simplified to be solvable by optical fiber measurement systems.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a diagram illustrating a workflow for focal mechanism inversion;

FIG. 2 is a graph illustrating event location (depicted as a star) and array geometry tested (vertical array, horizontal array, and scattered array);

FIG. 3 is a graph illustrating possible solution of strike, dip and rake presented in model space, whereby different shading indicates different clusters and a vertical array case is presented; and

FIG. 4 is a series of diagrams illustrating the focal plane geometry inverted by the present method and ground truth, whereby both the solutions indicated by the present method are reasonably close to the true solution.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers’ specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

The method disclosed herein solves a focal plane solution (3 parameters) from DAS (distributed acoustic sensing) with fiber optics cable. A focal plane solution is a simple representation of a deformation process at the source assuming the deformation is modeled as a slip of fault plane. It is often used in earthquake seismology because the majority of earthquakes are considered as a slip of fault plane. By introducing this assumption, one could describe the kinematics of fracturing associated with hydraulic fracturing.

Presently disclosed embodiments include a method comprising acquiring raw seismic data, computing event locations and corresponding P and S wave arrivals, automatically obtaining polarity of the corresponding P and S waves arrivals, measuring the fit of P and S wave polarity to a model to obtain a group of accepted solutions, analyzing the distribution of the accepted solutions in the model, and identifying a best solution as a focal mechanism. The raw seismic data is acquired using a distributed acoustic sensing system. The event location and the corresponding P and S wave arrivals are computed using an automated migration-based method (or other methods as long as it provides event location and P and S wave arrival information). The fitting of the P and S wave arrivals to the model is measured by revising the strike, drip, and rake of a focal plane geometry. In some cases, specific receivers, and/or certain P or S waves may be used depending on the availability of the data.

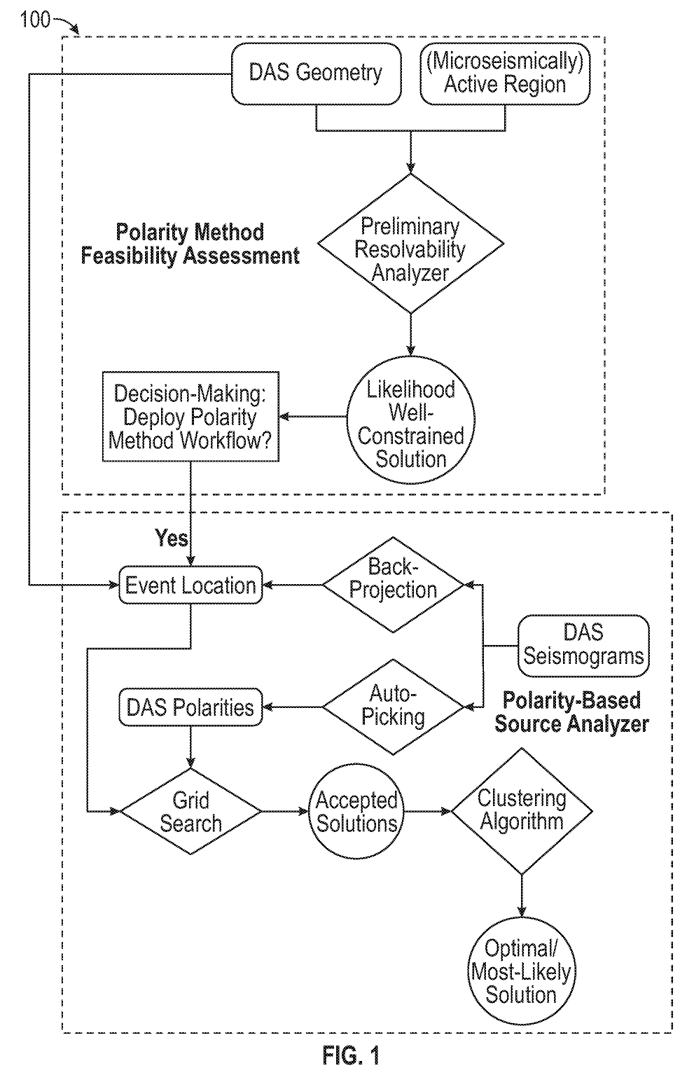

The distribution of the accepted solutions in the model is analyzed using clustering algorithms. The focal mechanism comprises three parameters: strike, dip, and rake. A feasibility study phase is done to determine if the method is applicable or not (see upper portion of FIG. 1). As a result of the feasibility study, it will be determined whether the focal mechanism can be estimated or not. Once the study determines that the focal mechanism is feasible to invert, the focal mechanism inversion step is initiated (see bottom portion of FIG. 1). Presently disclosed embodiments include a system comprising a processor, memory accessible to the processor, processor-executable instructions stored in the memory and executable by the processor to instruct the system to acquire raw seismic data, compute the event location and corresponding P and S wave arrivals, automatically obtain the polarity of the corresponding P and S waves arrivals, measure the fit of P and S wave polarity to a model to obtain a group of accepted solutions, analyze the distribution of the accepted solutions in the model, and identify a best solution as a focal mechanism. The raw seismic data is acquired using a distributed acoustic sensing system. The event location and the corresponding P and S wave arrivals are computed using an automated migration-based method but not limited to this method unless event location and P and S wave arrivals are estimated. The fitting of the P and S wave polarizations to the model is measured by revising the strike, drip, and rake of a focal plane geometry. The distribution of the accepted solutions in the model is analyzed using clustering algorithms.

### Workflow of the Method

FIG. 1 describes the entire workflow 100. The workflow starts from the feasibility study phase, and is followed by data processing step (source analyzer in the figure). The purpose of the feasibility study is to conclude if the method described is applicable or not. Once the feasibility study concluded, data processing step is started as described below:
a. Step 1: To acquire raw seismic data using the distributed acoustic sensing system.
b. Step 2: To compute event location and corresponding P and S wave arrivals. The migration-based method fully automates these processes. Once the P and S wave arrivals are computed, the polarity of P and S wave arrivals will be obtained automatically. It may be noted that this step can be replaced by other methods unless event location and P and S arrival times are estimated.
c. Step 3: To measure the fitting of P and S wave polarity to the model by revising strike, dip and rake of focal plane geometry, and obtain group(s) of accepted solutions.
d. Step 4: Analyze the distribution of accepted solutions in the model space using clustering algorithms, and identify best solution as focal mechanism (strike, dip and rake).

### Advantages of the Disclosed Methods

One advantage of the currently disclosed method includes the ability to handle both P and/or S wave polarization to invert focal mechanism versus only P waves. This flexibility gives a more reliable result when compared to the previously disclosed art.

Another advantage of the currently disclosed method includes employing the clustering algorithm to estimate the distribution of the possible solutions in model space efficiently.

### Implementation Example

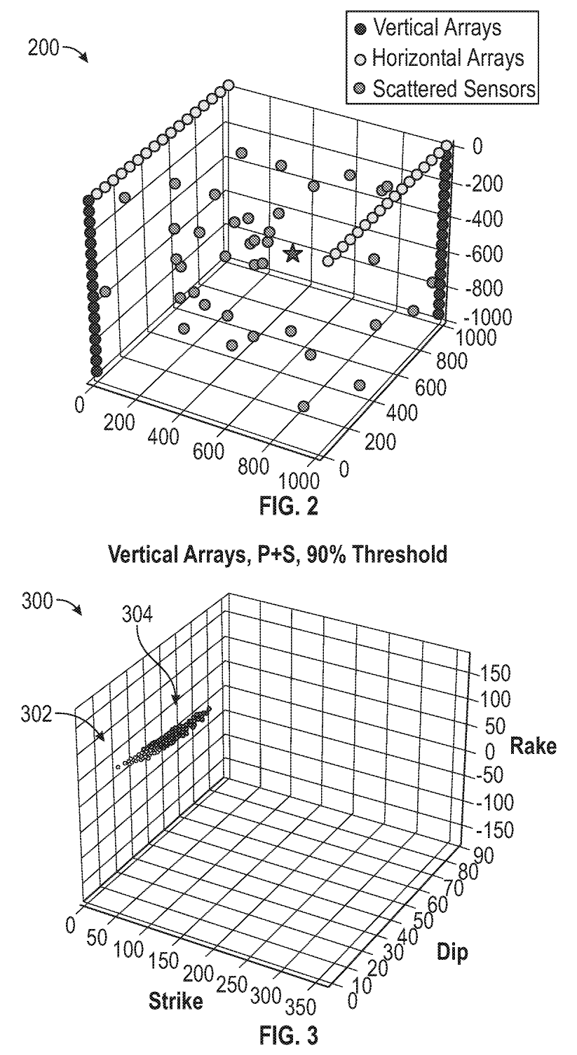

FIG. 2 shows an example 200 of geometry of DAS receivers strike, dip and rake of focal mechanism is N40 deg, 40 deg, and 50 deg respectively. The synthetic data is fed into the workflow

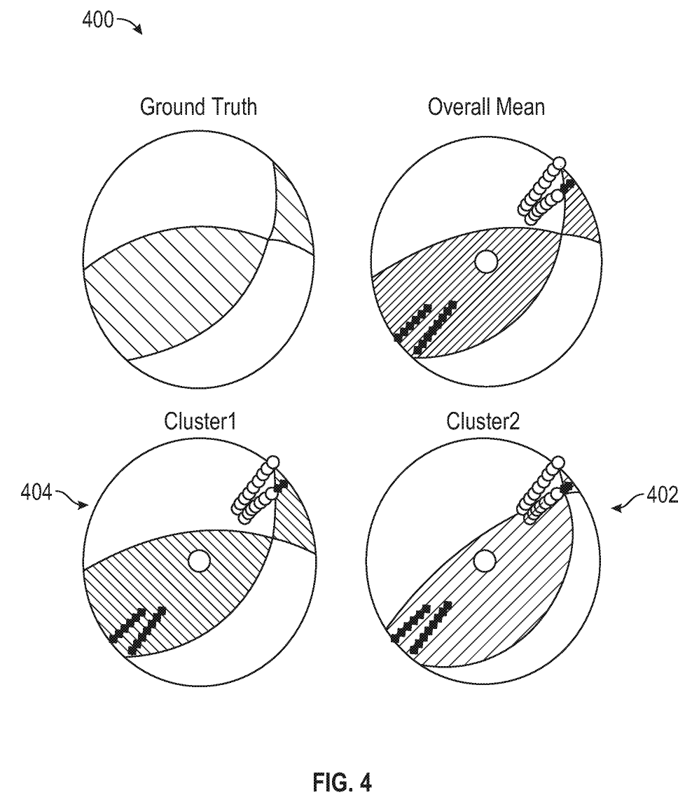

(FIG. 1), and a possible solution is obtained as shown in FIG. 3. In FIG. 3, a possible solution 300 of strike, dip, and rake are presented. The different shading 302, 304 indicates different clusters. FIG. 4 illustrates a comparison 400 between the present method and the ground truth. The clustering analysis indicates there are two possible solutions 402, 404 as shown in FIG. 4. The solutions 402, 404, are determined by the focal geometry inversion as disclosed herein, which are shown to be reasonably close to the ground truth or true solution.

Examples in the present disclosure may also be directed to a non-transitory computer-readable medium storing computer-executable instructions and executable by one or more processors of the computer via which the computer-readable medium is accessed. A computer-readable media may be any available media that may be accessed by a computer. By way of example, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Note also that the software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

and event location as shown by the star. The waveform is synthesized assuming homogenous isotropic velocity model. The

What is claimed is:

1. A method comprising:
acquiring raw seismic data;
computing an event location and corresponding P and S wave arrivals;
automatically obtaining polarity of the corresponding P and S waves arrivals;
measuring a fit of P and S wave polarity to a model to obtain a group of accepted solutions;
analyzing a distribution of the accepted solutions in the model; and
identifying a best solution as a focal mechanism.

2. The method of claim 1, wherein the raw seismic data is acquired using a distributed acoustic sensing system.

3. The method of claim 1, further comprising providing an estimate of confidence of the best solution.

4. The method of claim 1, wherein the event location and the corresponding P and S wave arrivals are computed using an automated method and a polarity of the P and S wave arrivals are computed.

5. The method of claim 3, wherein fitting of the P and S wave polarity to the model is measured by searching strike, drip, and rake of a focal plane geometry.

6. The method of claim 1, wherein the distribution of the accepted solutions in the model is analyzed using clustering algorithms.

7. The method of claim 1, wherein the focal mechanism comprises strike, dip, and rake.

8. The method of claim 1, wherein a feasibility study phase is done to determine if the method is applicable or not.

9. A system comprising:
a processor;
memory accessible to the processor;
processor-executable instructions stored in the memory and executable by the processor to instruct the system to:
acquire raw seismic data;
compute an event location and corresponding P and S wave arrivals;
automatically obtain a polarity of the corresponding P and S waves arrivals;
measure a fit of P and S wave polarity to a model to obtain a group of accepted solutions;
analyze a distribution of the accepted solutions in the model; and
identify a best solution as a focal mechanism.

10. The system of claim 9, wherein the raw seismic data is acquired using a distributed acoustic sensing system.

11. The system of claim 9, further comprising processor-executable instructions to instruct the system to provide an estimate of confidence of the best solution.

12. The system of claim 9, wherein the event location and the corresponding P and S wave arrivals are computed using an automated method and a polarity of the P and S wave arrivals are computed.

13. The system of claim 12, wherein fitting of the P and S wave polarity to the model is measured by searching strike, drip, and rake of a focal plane geometry.

14. The system of claim 9, wherein the distribution of the accepted solutions in the model is analyzed using clustering algorithms.

15. The system of claim 9, wherein the focal mechanism comprises strike, dip, and rake.

16. The system of claim 9, wherein a feasibility study phase is done to determine if the method is applicable or not.
